(19) United States
(12) Patent Application Publication
(10) Pub. No.: US 2007/0010020 A1
(43) Pub. Date: Jan. 11, 2007

(54) Method and device for monitoring of a catalyst

(76) Inventors: David Elfvik, Stockholm (SE); Bjorn Westerberg, Sodertalje (SE); Mattias Nyberg, Tullinge (SE)

Correspondence Address: OSTROLENK FABER GERB & SOFFEN, 1180 AVENUE OF THE AMERICAS, NEW YORK, NY, 100368403, US

(21) Appl. No.: 10/558,614

(22) PCT Filed: Jun. 4, 2004
(86) PCT No.: PCT/SE04/00874

§ 371 Date: Dec. 16, 2005

(30) Foreign Application Priority Data
Jun. 10, 2003 (SE) 03016722

(51) Int. Cl. G01N 31/10

(52) U.S. Cl. 436/37

(57) ABSTRACT

A method and a device for monitoring the functioning of an SCR catalyst in the exhaust line of a combustion engine, whereby a temperature value representing the temperature of exhaust gases flowing out of the SCR catalyst is calculated by use of a calculation model and is compared with a temperature value measured in the exhaust line downstream from the SCR catalyst. A computer program comprising program codes for implementation of the method, a medium readable by computer and having stored on it a computer program which is intended to enable a computer to implement said method, and an electronic control unit.

### FIELD OF THE INVENTION AND STATE OF THE ART

The present invention relates to a method and a device for monitoring the functioning of an SCR catalyst in the exhaust line of a combustion engine. The invention also relates to a computer program comprising program codes for implementation of said method, a computer-readable medium comprising a computer program stored thereon and adapted to cause a computer to implement said method, and an electronic control unit.

In order to meet prevailing exhaust cleaning requirements, today's motor vehicles are usually provided with a catalyst in the exhaust line to effect catalytic conversion of environmentally dangerous exhaust components to less environmentally dangerous substances. For it to be able to maintain desired or required exhaust cleaning, the catalyst must exhibit sufficiently good functionality. A catalyst degenerates with increasing operating time and its functionality after long use may be so poor that it has to be replaced by a new one. The service life of a catalyst cannot be estimated beforehand with any great precision, since catalyst degeneration depends largely on the operating conditions specific to each individual catalyst. Moreover, exhaust cleaning may be affected by various types of malfunctions or operational defects of the catalyst. A number of different methods have been proposed and developed for monitoring the functioning of a catalyst and thereby ensuring that it functions satisfactorily so that it is possible to achieve desired or required exhaust cleaning, and such methods include ones based on comparing an exhaust temperature value measured downstream from the catalyst with a corresponding calculated temperature value. Such methods are for example previously known from DE 4122787 A1 and DE 19714293 C1.

No reliable method has yet been developed for monitoring the functioning of a catalyst of SCR type (SCR=selective catalytic reduction). This type of catalyst is hereinafter referred to as an SCR catalyst. In the case of an SCR catalyst, a reducing agent, usually urea, is injected into the exhaust gases upstream from the catalyst. An SCR catalyst reduces selectively NOₓ in exhaust gases but not the oxygen in exhaust gases.

### OBJECT OF THE INVENTION

The object of the present invention is to provide a method and a device which easily and reliably make it possible to monitor the functioning of an SCR catalyst in the exhaust line of a combustion engine.

### SUMMARY OF THE INVENTION

According to the invention, said object is achieved by means of a method exhibiting the features indicated in claim 1 and a device exhibiting the features indicated in claim 9.

The solution according to the invention comprises:
the generating, by measurement in the exhaust line upstream from the SCR catalyst, of a first temperature value representing the temperature of exhaust gases in the exhaust line upstream from the SCR catalyst,
calculating by means of a calculation model taking into account the measured first temperature value and the expected reactions in the SCR catalyst under prevailing operating conditions to calculate a second temperature value representing the temperature of exhaust gases flowing out of the SCR catalyst, whereby the second temperature value is calculated on the basis of at least the first temperature value, the NO_{X} concentration in the exhaust gases upstream from the SCR catalyst and an amount of reducing agent injected,
the generating, by measurement in the exhaust line downstream from the SCR catalyst, of a third temperature value representing the temperature of exhaust gases flowing out of the SCR catalyst, and
comparison of the third temperature value with the second temperature value in order to generate information relating to the functioning of the SCR catalyst.
   The solution according to the invention provides an easy and reliable way of monitoring whether the catalyst is functioning satisfactorily or not.

Special embodiments of the method according to the invention and the device according to the invention are indicated by the dependent claims and the ensuing description.

The invention also relates to a computer program according to claim 16 which is loadable directly to the internal memory of a computer and which comprises program codes for implementation of the method according to the invention.

The invention also relates to a computer readable medium according to claim 17 which comprises a computer program stored on it and intended to enable a computer to implement the method according to the invention.

The invention also relates to an electronic control unit according to claim 18.

### BRIEF DESCRIPTION OF THE DRAWINGS

The invention will be described in more detail below on the basis of examples with reference to the attached drawings, in which:

FIG. 1 depicts a schematic diagram of a combustion engine with relating catalyst, illustrating a first embodiment of the device according to the invention,

FIG. 2 depicts a schematic diagram of a combustion engine with relating catalyst, illustrating a second embodiment of the device according to the invention,

FIG. 3 depicts a schematic diagram of a combustion engine with relating catalyst, illustrating a third embodiment of the device according to the invention,

FIG. 4 depicts a flow diagram illustrating a method according to the present invention, and

FIG. 5 depicts a block diagram illustrating an electronic control unit for implementation of the method according to the invention.

### DETAILED DESCRIPTION OF EMBODIMENTS

FIGS. 1, 2 and 3 depict schematically a combustion engine provided with a device according to the invention. The combustion engine is schematically indicated by ref. 1. The exhaust gases leaving the combustion engine 1 travel through an exhaust line 2 and emerge into the environment via an exhaust outlet 3. An SCR catalyst 4 is arranged in the exhaust line 2. The exhaust gases from the combustion engine 1 are thus caused to pass through this SCR catalyst 4 before they emerge into the environment via the exhaust outlet 3. A reducing agent injection point 5 is situated in the exhaust line 2 upstream from the SCR catalyst 4. The injection of reducing agent is by means of an injection device comprising one or more injection means 6 in the form of injection nozzles or the like arranged in the exhaust line, and, connected thereto, a reducing agent storage container 7. The injection device further comprises a regulating means 8, such as a control valve or the like, arranged to regulate the supply of reducing agent to said injection means 6, and a control means 9 connected to the regulating means 8. The regulating means 8 is controlled by said control means 9 which determines how much reducing agent to inject into the exhaust gases on the basis of prevailing operating conditions of the combustion engine 1 and the SCR catalyst 4. The injection device may also comprise further components, such as a proportioning arrangement etc.

The reducing agent takes the form preferably of urea (CO(NH₂)₂) but may also take the form of ammonia (NH₃) or hydrocarbon (fuel). Both exothermic and endothermic reactions take place in the SCR catalyst, but in total the reactions in the SCR catalyst are exothermic, which means that heat is released and the catalyst is warmed up by the reactions in it. According to the invention, these reactions are taken into account in monitoring the functioning of the SCR catalyst 4.

The device 20 according to the invention comprises a first temperature sensor 21 arranged in the exhaust line 2 upstream from the SCR catalyst 4. This first temperature sensor 21 is arranged to generate a temperature value T1, here called the first temperature value, representing the temperature of the exhaust gases in the exhaust line upstream from the SCR catalyst 4. According to a first embodiment illustrated in FIG. 1, the first temperature sensor 21 is arranged in the exhaust line 2 upstream from the SCR catalyst 4 and downstream from the reducing agent injection point 5 arranged in the exhaust line. In this case the first temperature sensor 21 is arranged to generate a temperature value T1 representing the temperature of the exhaust gases flowing into the SCR catalyst 4, i.e. the exhaust temperature at the inlet of the SCR catalyst. As the first temperature sensor 21 is situated downstream from the injection point 5, this temperature sensor will measure the temperature of the exhaust gases after the addition of reducing agent. The effect of the reducing agent on the exhaust gas temperature upstream from the SCR catalyst will thus affect the first temperature value T1. When the reducing agent is injected into the exhaust gases, there is evaporation of reducing agent due to the heat from the exhaust gases, thereby leading to a decrease in the temperature of the exhaust gases.

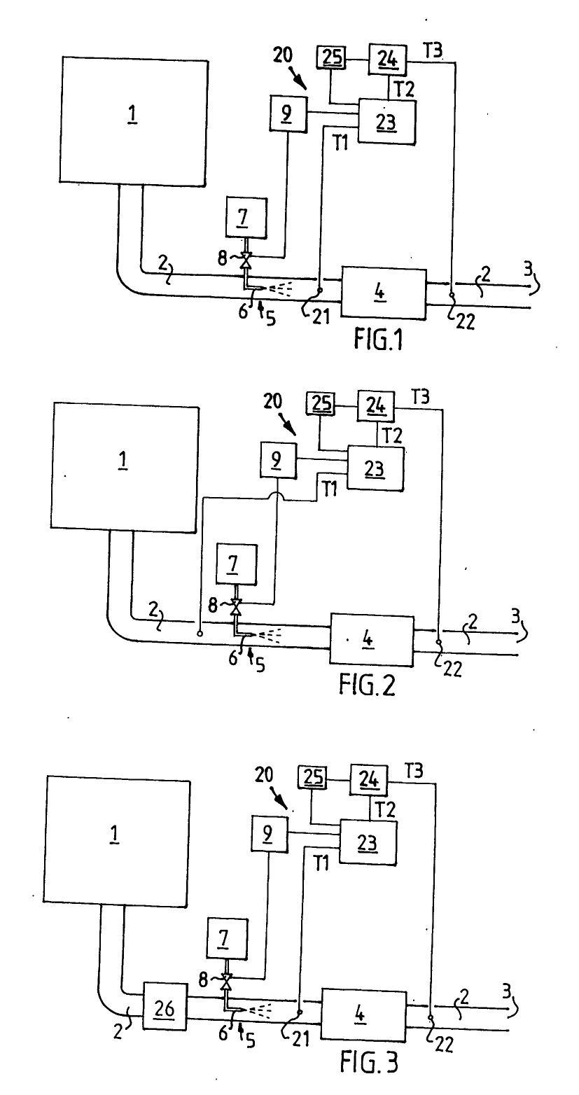

According to a second embodiment illustrated in FIG. 2, the first temperature sensor 21 is arranged in the exhaust line 2 upstream from, the SCR catalyst 4 and also upstream from the reducing agent injection point 5 arranged in the exhaust line. In this case the temperature of the exhaust gases flowing into the SCR catalyst 4, i.e. the exhaust temperature at the inlet of the SCR catalyst, can be determined by calculation on the basis of the measured first temperature value T1 and an amount of reducing agent injected into the exhaust gases.

The device also comprises a second temperature sensor 22 arranged in the exhaust line 2 downstream from the SCR catalyst 4. This second temperature sensor 22 is arranged to generate a temperature value T3, here called the third temperature value, representing the temperature of the exhaust gases flowing out of the SCR catalyst 4, i.e. the exhaust temperature at the outlet of the SCR catalyst. Said first and second temperature sensors 21, 22 may be arranged as close as possible to the inlet and outlet respectively of the SCR catalyst.

The device 20 further comprises a calculation means 23 arranged to calculate a temperature value T2, here called the second temperature value, representing the temperature of the exhaust gases flowing out of the SCR catalyst 4. The second temperature value T2 thus constitutes a value arrived at theoretically for the exhaust temperature at the outlet of the SCR catalyst. This calculation means 23 is arranged to calculate the second temperature value T2 by means of a calculation model which takes into account the first temperature value T1 measured by the first temperature sensor 21 and the expected exothermic and endothermic reactions in the SCR catalyst 4 under prevailing operating conditions. The calculation model thus takes into account the exothermic and endothermic reactions which take place in the SCR catalyst 4 when an amount of reducing agent expected for the prevailing operating conditions is injected into the exhaust gases at the injection point 5. The calculation model may take any desired form so long as it provides with desired accuracy a correct value for the expected exhaust temperature at the outlet of the SCR catalyst. The calculation model is preferably designed to generate a temperature value T2 which represents the expected temperature of exhaust gases flowing out of a fully functional SCR catalyst upon an injection of reducing agent expected for prevailing operating conditions. Should it be found advantageous, the calculation model might instead be designed to generate a temperature value T2 which represents the expected temperature of exhaust gases flowing out of a functional but somewhat degenerated SCR catalyst upon an injection of reducing agent expected for prevailing operating conditions.

The device further comprises means 24 for determining the functioning of the SCR catalyst 4 on the basis of comparison between the measured third temperature value T3 and the calculated second temperature value T2. Said means 24 is thus arranged to receive the third temperature value T3 from the second temperature sensor 22 and the second temperature value T2 from the calculation means 23 and comprises a comparator for mutual comparison of these temperature values T2, T3. In cases where the calculation model used is designed to generate a temperature value T2 which represents the expected temperature of exhaust gases flowing out of a fully functional SCR catalyst, the measured third temperature value T3 should in this ideal case coincide with the calculated second temperature value T2 if the SCR catalyst 4 is fully functional and there is a correct injection of reducing agent. On the basis of the relationship (e.g. difference, ratio or correlation) between the third temperature value T3 and the second temperature value T2 it is possible to determine whether the SCR catalyst 4 and its injection device are functioning in a satisfactory and expected manner or not. An indication obtained from comparison between the third temperature value T3 and the second temperature value T2 that the SCR catalyst 4 and/or its injection device is/are not functioning satisfactorily may for example be due to one or more of the following causes:
no reducing agent or not the intended reducing agent being injected by the injection device,
the injection device defective and not injecting expected amount of reducing agent,
the SCR catalyst 4 not functional, e.g. due to degeneration,
the SCR catalyst 4 not in place, e.g. if a silencer has been mistakenly placed at the location intended for the catalyst,
one or more of the input signals to the calculation model being incorrect,
either of the temperature sensors 21, 22 being faulty.
   In the event of an indication of the type mentioned, the conceivable causes thus need checking with a view to determining and correcting the cause of the fault concerned.

The aforesaid calculation model is with advantage designed to use the following parameters as input values:
a) The first temperature value T1 measured by the first temperature sensor 21.
b) The NO_{X} concentration in the exhaust gases upstream from the SCR catalyst. This concentration may be determined by sensor but is with advantage determined by any of the conventional ways of calculating it, e.g. on the basis of the combustion engine's load, speed, injection angle (i.e. the angle of the combustion engine's crankshaft at the time of fuel injection into the engine cylinder) and, where applicable, EGR content (EGR=exhaust gas recirculation), i.e. the proportion of exhaust gases led back to the engine.
c) The exhaust mass flow through the SCR catalyst. This exhaust mass flow may be determined by means of mass flow sensor but is with advantage determined by any of the conventional ways of calculating it, e.g. on the basis of the combustion engine's load and speed.
d) Amount of reducing agent injected into the exhaust gases. The value for amount of reducing agent injected is obtained with advantage from the control means 9 of the injection device.

The calculation model may also use as input value/values the O₂ concentration in the exhaust gases upstream from the SCR catalyst and/or the ambient temperature. The O₂ concentration may be determined by, for example, lambda sensor but is with advantage determined by any of the conventional ways of calculating it, e.g. on the basis of the combustion engine's load, speed and, where applicable, EGR content.

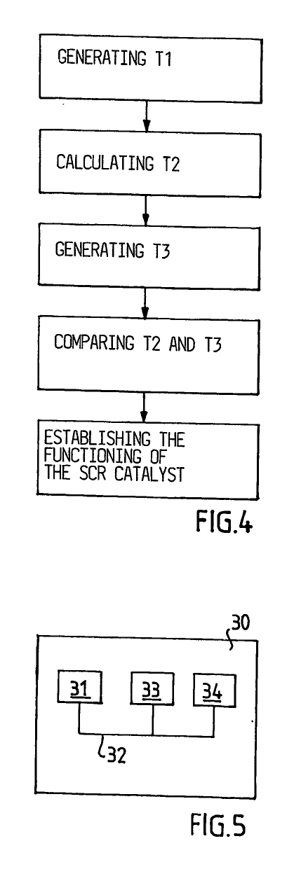

In cases where an oxidation catalyst 26, as illustrated in FIG. 3, is arranged upstream from the SCR catalyst 4 in order partly to convert NO occurring in the exhaust gases to NO₂, the ratio between NO and NO₂ downstream from the oxidation catalyst should also be used as an input value in calculating the second temperature value T2.

The device comprises with advantage a calibration means 25 for mutual calibration of the second temperature value T2 and the third temperature value T3 in one or more situations when the combustion engine is running and it has been found that no or only insignificant exothermic reactions are taking place in the SCR catalyst. Such a calibration situation is characterised either by there being no reducing agent or only an insignificant amount of reducing agent stored in the catalyst, a fact determined by means of the aforesaid calculation model, or by there being no NOₓ or only an insignificant concentration of NO, in the exhaust gases passing through the SCR catalyst, a fact determined in the manner indicated above by sensor or calculation. In either case there is no injection of reducing agent. Calibration is done by adapting the calculation model and/or the first temperature sensor 21 and/or the second temperature sensor 22 so that the second temperature value T2 will coincide with the third temperature value T3 in said situation. Adjustment of the device while it is in operation is thus made possible.

The calculation means 23, the means 24 for determining the functioning of the SCR catalyst 4 and, where applicable, the calibration means 25 are integrated with advantage in a common computer unit but may, if it be found advantageous, constitute separate but mutually communicating units. Integration of the control means 9 of the injection device in said common computer unit is also advantageous, but said control means may, if it be found advantageous, constitute a separate unit communicating with the calculation means 23.

The monitoring device 20 according to invention also suitably comprises some form of alarm device arranged, for example, in or in the vicinity of the vehicle's instrument panel to provide the vehicle's driver with a warning signal upon detection of an incorrect situation. Should the monitoring device 20 find that the SCR catalyst 4 and/or its injection device is/are not functioning satisfactorily, an actuating signal is sent to this alarm device, which will indicate by, for example, a light signal and/or sonic signal that there is an incorrect situation.

Program codes for implementation of the method according to the invention are preferably arranged to form part of a computer program directly loadable to the internal memory of a computer, e.g. the internal memory of the aforesaid computer unit. Such a computer program is supplied suitably stored on a storage medium readable by computer, e.g. an optical storage medium in the form of a CD-ROM disc, a DVD disc etc., or a magnetic storage medium in the form of a diskette, a cassette tape etc. FIG. 5 illustrates an electronic control unit 30 comprising a means 31, preferably a central processor unit (CPU), for execution of software, which communicates via a databus 32 with a memory 33, e.g. of the RAM (random access memory) type. The control unit 30 also includes a storage means 34, e.g. in the form of a memory of the PROM (programmable read only memory) type or a flash memory, with which the execution means 31 communicates via the databus 32. A computer program comprising program codes for implementing the method according to the invention is stored in the storage means 34.

A form of calculation model suitable for use in a method and in a device according to the present invention for determining the aforesaid second temperature value T2 is described below.

In an SCR catalyst, nitrogen oxide (NOₓ) reacts with ammonia and is reduced to nitrogen gas. NOₓ is the harmful component intended to be removed from the exhaust gases, and ammonia is the reducing agent used for the purpose. Ammonia or urea (which converts to ammonia) is sprayed into the exhaust gases upstream from the SCR catalyst. The calculation model is used to determine how much NOₓ is converted in the SCR catalyst and how much unconsumed ammonia leaves the SCR catalyst. The temperature of the exhaust gases leaving the SCR catalyst, i.e. the second temperature value T2, is also obtained from the calculation model. The calculation model calculates continuously how the temperature varies through the catalyst and how much ammonia is stored in different parts of the catalyst. To this end, the calculation model needs to be continuously supplied with information about the magnitude of the gas flow through the catalyst and the temperature and composition of the gases flowing into the catalyst.

A number of reactions take place in the SCR catalyst. Ammonia is absorbed on the active seats in the catalyst, resulting in storage of ammonia in the catalyst. The stored ammonia may either be desorbed, i.e. released from the active seats, or react with NOₓ. At high temperatures there is also to some extent oxidation of ammonia with oxygen. How much NOₓ is converted in the catalyst depends on the reaction rates Γᵢ of the various reactions. The reactions and their relating reaction rates are as follows:
S+NH₃→S.NH₃r₁=k₁c_{NH3}θᵥ 1)
S.NH₃→S+NH₃r₂=k₂θ_{NH3} 2)
4S.NH₃+4NO+O₂→4S+4N₂+6H₂Or₃=k₃c_{NO}θ_{NH3} 3)
4S.NH₃+5O₂→4S+6H₂O+4NOr₄=k₄c_{O2}θ_{NH3} 4)
where kᵢ is the rate constant for reaction i, cᵢ is the concentration of substance i, θᵥ is the proportion of vacant seats and θ_{NH3} is the proportion of seats occupied by ammonia. The reaction rates rᵢ are temperature-dependent in accordance with the Arrhenius equation:

$${k}_{i} = {k}_{0 , i} {ⅇ}^{- \frac{{E}_{A , i}}{RT}}$$

where k_{0,i} is constant for reaction i, E_{A,i} is the activating energy for reaction i, R is the general gas constant and T is the temperature.

To determine how much stored ammonia there is in different parts of the SCR catalyst, a number of material balances are solved according to the calculation model. As the SCR catalyst has a monolithic structure, the gas flows through small ducts where the walls between the ducts contain the active catalyst material. The catalyst is modelled by looking at the flow through a duct divided into a number of segments. The material balances are solved successively from the segment at the catalyst inlet to the segment at the catalyst outlet. From the flow through the duct, NOₓ and ammonia are transported into the duct wall, where these substances react. To cater for the effects of the rate at which the substances are transported to the duct wall and into the duct wall, the duct wall is also divided into a number of segments. As all the material balances in the wall segments within a given duct segment are connected to one another, they have to be solved together in one equation system. The calculation model sets up the following material balances:

$${F}_{tot} ( {y}_{i , k - 1} - {y}_{i , k} ) - {Γ}_{i , k , 0} ( {c}_{i , k , 0} - {c}_{i , k , 1} ) = 0$$

$${Γ}_{i , k , n - 1} ( {c}_{i , k , n - 1} - {c}_{i , k , n} ) - {Γ}_{i , k , n} ( {c}_{i , k , n} - {c}_{i , k , n + 1} ) + {\sum }_{j} {v}_{i , j} {r}_{j , k , n} {w}_{k , n} = 0$$

$$when n \geq 1$$

where Fₜₒₜ is the total molar flow, y_{i,k} and c_{i,k} are the molar proportion and concentration respectively of substance i in duct segment k, Γ_{i,k,o} and Γ_{i,k,n} are the respective coefficients for transport of substance i from the gas flow to the first wall segment and between wall segments n and n+1 in duct segment k, v_{i,j} is the stoechiometric coefficient for substance i in reaction j, Γ_{j,k,n} is the reaction rate for reaction j in duct segment k and wall segment n and w_{k,n} is the mass of active catalyst material in duct segment k and wall segment n. The accumulation of ammonia in duct segment k and wall segment n is then arrived at by the material balance:

$${N}_{c} \frac{ⅆ {θ}_{{NH}_{3} , k , n}}{ⅆ t} = {\sum }_{j} {v}_{i , j} {r}_{j , k , n}$$

where N_{c} is the number of active seats per mass of catalyst material.

To determine the temperature through the SCR catalyst, a heat balance for the gas and a heat balance for the catalyst are solved according to the calculation model in a similar manner. The heat balance for the gas is given by:
Fₜₒₜcₚ(T_{g,k-1}−T_{g,k})−hₖAₖ(T_{g,k}−T_{s,k})=0
where T_{g,k} and T_{s,k} are the gas temperature and catalyst temperature respectively in duct segment k, cₚ is the heat capacity for the gas, hₖ is the heat transfer coefficient in duct segment k and Aₖ is the wall surface area in duct segment k. The heat balance for the catalyst is given by:

$${m}_{s , k} {c}_{p , s} \frac{ⅆ {T}_{s , k}}{ⅆ t} = {h}_{k} {A}_{k , 0} ( {T}_{g , k} - {T}_{s , k} ) + {\sum }_{n} {\sum }_{j} {r}_{j , k , n} {w}_{k , n} ( - Δ {H}_{j} )$$

where m_{s,k} is the mass of catalyst in duct segment k, c_{p,s} is the heat capacity for the catalyst material and −ΔHⱼ is the reaction heat for reaction j.

As may be perceived by a specialist in this field, the calculation model indicated above may be modified in many different ways and it is also possible to use a different type of calculation model than that indicated for determining the second temperature value T2.

The invention is of course in no way limited to the preferred embodiments described above, as a multiplicity of possibilities for modifications thereof are likely to be obvious to a specialist in this field, without having for that purpose to deviate from the basic concept of the invention as defined in the attached claims. The exhaust system may for example comprise at least one additional catalyst connected in series with the SCR catalyst, e.g. an oxidation catalyst and/or a hydrolosis catalyst upstream from the SCR catalyst and/or a slip catalyst downstream from the SCR catalyst.

1. A method for monitoring the functioning of an SCR catalyst in the exhaust line of a combustion engine, comprising
generating a first temperature value (T1) representing the temperature of exhaust gases in the exhaust line upstream from the SCR catalyst by a measurement in the exhaust line upstream from the SCR catalyst,
calculating a second temperature value (T2) representing the temperature of exhaust gases flowing out of the SCR catalyst by means of a calculation model which takes into account the measured first temperature value (T1) and an expected reaction in the SCR catalyst under prevailing operating conditions, whereby the second temperature value (T2) is calculated on the basis of at least the first temperature value (T1), the NOₓ concentration in the exhaust gases upstream from the SCR catalyst, and an injected amount of reducing agent,
generating a third temperature value (T3) representing the temperature of exhaust gases flowing out of the SCR catalyst by a measurement in the exhaust line downstream from the SCR catalyst, and
comparing the third temperature value (T3) with the second temperature value (T2) in order to generate information concerning the functioning of the SCR catalyst.

2. A method according to claim 1, wherein the first temperature value (T1) is generated by measurement in the exhaust line upstream from the SCR catalyst and downstream from a reducing agent injection point arranged in the exhaust line.

3. A method according to claim 1, wherein the second temperature value (T2) is also calculated on the basis of at least the exhaust mass flow through the SCR catalyst.

4. A method according to claim 3, further comprising taking the O₂ concentration in the exhaust gases upstream from the SCR catalyst into account as a parameter in calculating the second temperature value (T2).

5. A method according to claim 3, further comprising taking the ambient temperature into account as a parameter in calculating the second temperature value (T2).

6. A method according to claim 3, further comprising arranging an oxidation catalyst upstream from the SCR catalyst, and taking into account the ratio between NO and NO₂ in the exhaust gases upstream from the SCR catalyst account as a parameter in calculating the second temperature value (T2).

7. A method according to claim 1, further comprising dividing the SCR catalyst according to the calculation model along the longitudinal direction of the SCR catalyst into a multiplicity of segments and the calculations for determining the second temperature value (T2) are successive calculations starting with the segment situated closest to an input end of the SCR catalyst.

8. A method according to claim 1, further comprising calibrating the second temperature value (T2) and the third temperature value (T3) mutually on at least one occasion when the combustion engine is running and it has been found that no or only insignificant exothermic reactions are taking place in the SCR catalyst.

9. A device for monitoring the functioning of an SCR catalyst in an exhaust line of a combustion engine, the device comprising:
a first temperature sensor arranged in the exhaust line upstream from the SCR catalyst to generate a first temperature value (T1) representing the temperature of exhaust gases in the exhaust line upstream from the SCR catalyst,
a calculation device operable to calculate a second temperature value (T2) representing the temperature of exhaust gases flowing out of the SCR catalyst by means of a calculation model which takes into account the measured first temperature value (T1) and the expected reactions in the SCR catalyst under prevailing operating conditions, whereby the second temperature value (T2) is calculated on the basis of at least the first temperature value (T1), the NO_{X} concentration in the exhaust gases upstream from the SCR catalyst, and an injected amount of reducing agent,
a second temperature sensor arranged in the exhaust line downstream from the SCR catalyst operable to generate a third temperature value (T3) representing the temperature of exhaust gases flowing out of the SCR catalyst, and
a determining device operable to determine the functioning of the SCR catalyst on the basis of a comparison between the third temperature value (T3) and the second temperature value (T2).

10. A device according to claim 9, further comprising a reducing agent injection point arranged in the exhaust line, wherein the first temperature sensor is arranged upstream from the SCR catalyst and downstream from a reducing agent injection point.

11. A device according to claim 9 wherein the calculation device is operable to calculate the second temperature value (T2) also on the basis of at least the exhaust mass flow through the SCR catalyst.

12. A device according to claim 11, wherein the calculation device is operable to also take the O₂ concentration in the exhaust gases upstream from the SCR catalyst into account as a parameter in calculating the second temperature value (T2).

13. A device according to claim 11, wherein the calculation device is operable to also take the ambient temperature into account as a parameter in calculating the second temperature value (T2).

14. A device according to claim 11, further comprising an oxidation catalyst arranged upstream from the SCR catalyst, and the calculation device is operable to also take the ratio between NO and NO₂ in the exhaust gases upstream from the NCR-catalyst into account as a parameter in calculating the second temperature value (T2).

15. A device according to claim 9, further comprising a calibration device for mutual calibration of the second temperature value (T2) and the third temperature value (T3) on at least one occasion when the combustion engine is running and it has been found that no or only insignificant exothermic reactions are taking place in the SCR catalyst.

16. A computer program which is directly loadable to the internal memory of a computer and comprises program codes for implementation of a method for monitoring the functioning of an SCR catalyst in the exhaust line of a combustion engine the method comprising:
generating a first temperature value (T1) representing the temperature of exhaust gases in the exhaust line upstream from the SCR catalyst by a measurement in the exhaust line upstream from the SCR catalyst,
calculating a second temperature value (T2) representing the temperature of exhaust gases flowing out of the SCR catalyst by means of a calculation model which takes into account the measured first temperature value (T1) and an expected reaction in the SCR catalyst under prevailing operating conditions, whereby the second temperature value (T2) is calculated on the basis of at least the first temperature value (T1), the NO_{X} concentration in the exhaust gases upstream from the SCR catalyst, and an injected amount of reducing agent.
generating a third temperature value (T3) representing the temperature of exhaust gases flowing out of the SCR catalyst by a measurement in the exhaust line downstream from the SCR catalyst, and
comparing the third temperature value (T3) with the second temperature value (T2) in order to generate information concerning the functioning of the SCR catalyst.

17. A medium which is readable by a computer and has stored on it a computer program which is directly loadable to the internal memory of a computer and comprises program codes for implementation of a method for monitoring the functioning of an SCR catalyst in the exhaust line of a combustion engine the method comprising:
generating a first temperature value (T1) representing the temperature of exhaust gases in the exhaust line upstream from the SCR catalyst by a measurement in the exhaust line upstream from the SCR catalyst,
calculating a second temperature value (T2) representing the temperature of exhaust gases flowing out of the SCR catalyst by means of a calculation model which takes into account the measured first temperature value (T1) and an expected reaction in the SCR catalyst under prevailing operating conditions, whereby the second temperature value (T2) is calculated on the basis of at least the first temperature value (T1), the NO_{X} concentration in the exhaust gases upstream from the SCR catalyst and an injected amount of reducing agent,
generating a third temperature value (T3) representing the temperature of exhaust gases flowing out of the SCR catalyst by a measurement in the exhaust line downstream from the SCR catalyst, and
comparing the third temperature value (T3) with the second temperature value (T2) in order to generate information concerning the functioning of the SCR catalyst.

18. An electronic control unit comprising an execution means, a memory connected to the execution means and a storage medium connected to the execution means, and the computer program according to claim 16 stored in the storage medium.
